(19) United States
(12) Patent Application Publication
(10) Pub. No.: US 2015/0205009 A1
(43) Pub. Date: Jul. 23, 2015

(54) RAIN GUAGE WITH FLEXIBLE BOTTOM

(71) Applicant: Robert Wayne Presley, JR., Carbondale, IL (US)

(72) Inventor: Robert Wayne Presley, JR., Carbondale, IL (US)

(21) Appl. No.: 14/243,645

(22) Filed: Apr. 2, 2014

Related U.S. Application Data
(60) Provisional application No. 61/929,404, filed on Jan. 20, 2014.

(51) Int. Cl. G01W 1/14

(52) U.S. Cl. CPC G01W 1/14

(57) ABSTRACT

A rain gauge with a flexible bottom is provided. The rain gauge may include a tube, where water is collected. The tube may include a top end and a bottom end. The top end includes a rim forming an opening leading into the tube. A printed scale may be on the surface of the tube to measure the amount of water within the tube. The printed scale may include a plurality of graduation markings along the length of the tube with a plurality of numeric markings corresponding with the graduation markings. The rain gauge may include a cap covering the bottom end of the tube. The cap is made of a flexible material, such as a flexible polymer.

### CROSS-REFERENCE TO RELATED APPLICATION

This application claims the benefit of priority of U.S. provisional application No. 61/929,404, filed Jan. 20, 2014, the contents of which are herein incorporated by reference.

### BACKGROUND OF THE INVENTION

The present invention relates to a rain gauge and, more particularly, to a rain gauge with a flexible bottom.

Common rain gauges are clear tubes with volume measuring rulers affixed to them. When rain is collected in the gauges, the user notices where the top of the water column registers on the scale to determine how much rain has fallen. These gauges break when the water inside them freezes. As the water freezes, it expands and exerts pressure on the walls and bottom of the gauge which breaks them. Retail packaging comes with warnings not to let them freeze.

Ways to prevent the breaking of the gauges may include using antifreeze, a heating mechanism, tubes made entirely from translucent flexible polymers. Replacing antifreeze each time the gauge is emptied is troublesome for the user, and safe disposal of the antifreeze could be problematic. Wires must be run to the electric defroster, which is expensive and limits the placement of the gauge to locations which provide electricity. Flexible polymers typically exhibit the lack of optical clarity found in clear rigid polymers, and are prone to degradation when exposed to sunlight for extended periods of time. The optically translucent nature of flexible polymers make it more difficult for the user to see the level of rain in the gauge, and the problem worsens over time as the polymer is exposed to UV rays.

As can be seen, there is a need for an inexpensive and easy to use device for preventing gauges from breaking in freezing temperatures.

### SUMMARY OF THE INVENTION

In one aspect of the present invention, a rain gauge comprises: a tube comprising a clear rigid body with a top end and a bottom end, wherein the top end comprises a rim forming an opening leading into the tube; a plurality of graduation markings along the length of the tube; and a cap comprising a flexible material covering the bottom end of the tube.

These and other features, aspects and advantages of the present invention will become better understood with reference to the following drawings, description and claims.

### BRIEF DESCRIPTION OF THE DRAWINGS

FIG. 1 is a perspective view of the present invention attached to an exemplary stand;

FIG. 2 is an exploded view of the present invention;

FIG. 3 is a section view of the present invention taken along line 3-3 in FIG. 1; and

FIG. 4 is a section view of the present invention with the membrane of FIG. 1 expanded.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a rain gauge that will not break when the water inside is frozen. The freeze proof rain gauge may include a clear, rigid hollow cylinder or tube, open on both ends, which features a cap or flexible bottom membrane, which expands as the ice expands. This relieves the pressure on the walls and bottom of the cylinder and avoids breakage. The present invention is less expensive and easier to use than the prior art.

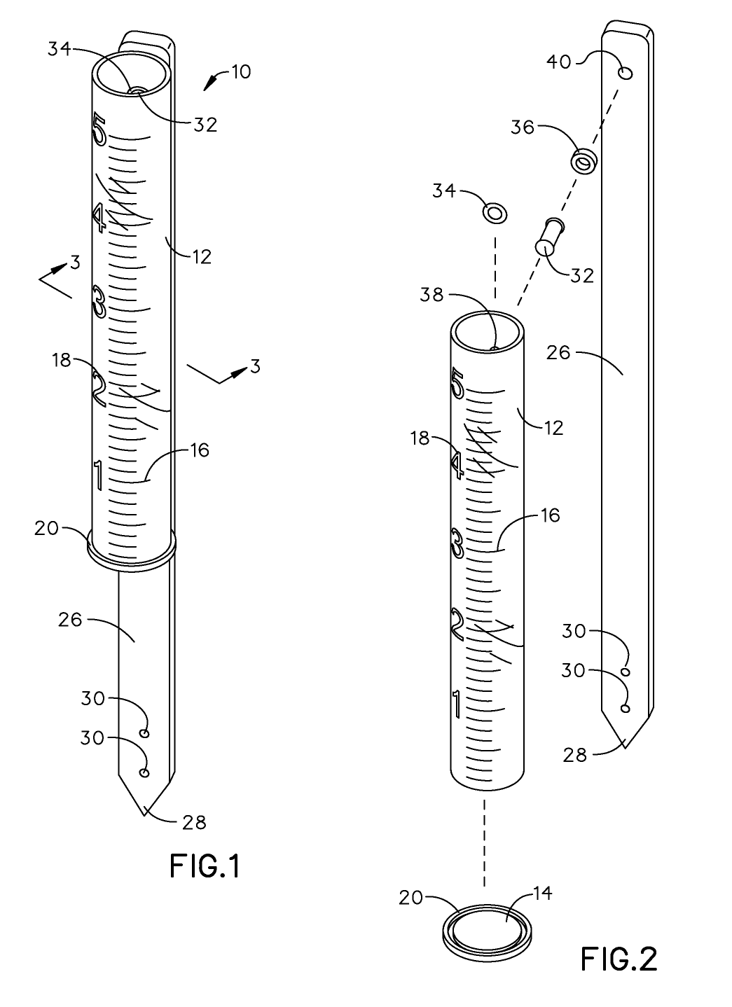

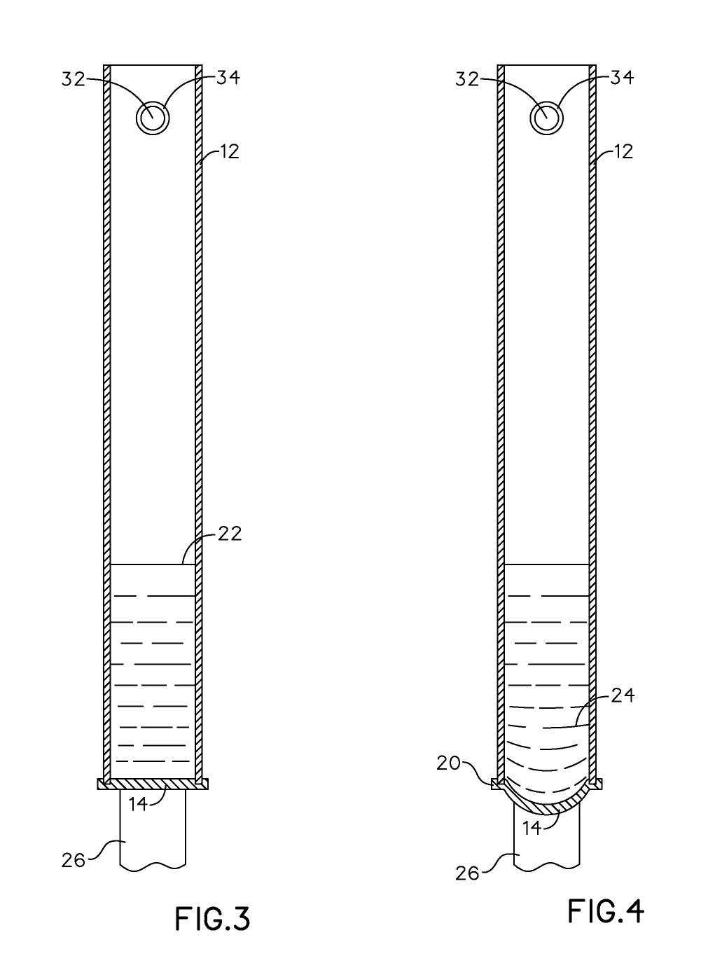

Referring now to FIGS. 1 through 4, the present invention may include a rain gauge 10. The rain gauge 10 may include a tube 12, where water is collected. The tube 12 may include a top end and a bottom end. The top end includes a rim forming an opening leading into the tube. A printed scale may be on the surface of the tube 12 to measure the amount of water within the tube 12. The printed scale may include a plurality of graduation markings 16 along the length of the tube 12 with a plurality of numeric markings 18 corresponding with the graduation markings 16. The rain gauge 10 may include a cap 20 on the bottom which is made of a flexible material 14, such as a flexible polymer. The flexible polymer may be rubber.

In certain embodiments, bottom end of the tube 12 may include a bottom rim forming a bottom opening leading into the tube 12. The flexible cap 20 of the present invention may cover the bottom opening. In certain embodiments, the cap 20 includes a top surface and a bottom surface. The top surface may include a circumferential channel. The bottom rim of the tube 12 is formed to fit within the circumferential channel and attach to the cap 20. As illustrated in the Figures, a portion of the top surface of the cap 20 may protrude within the tube 20.

In certain embodiments, the cap 20 of the present invention may be attached to the bottom end of the clear polymer tube 12 and may either be kept in place by being attached with a fastener, such as an adhesive, or molded in place using a self-adhesive polymer. When accumulated rain 22 freezes into ice 24 in the tube 12, the flexible material 14 of the cap 20 expands downward as illustrated in FIG. 4 and releases pressure on the walls and bottom of the tube 12. Therefore, the tube 12 does not crack due to the pressure.

The present invention may include a support holder 26 configured to support the tube 12 in an upright position in order to collect rain 22. The support holder 26 may include a stake 28. The tube 12 may be attached to the stake 28. In certain embodiments, the tube 12 may include an aperture 38 near the top end. The stake 28 may include an aligned aperture 40. The tube 12 and the stake are attached via a rivet 32, a spacer 36 and a washer 34 through the aperture 32 of the tube 12 and the aligned aperture 40 of the stake 28.

In certain embodiments, the tube 12 may be made of any clear strong rigid material, and may be round, square or have any number of sides. The pressure-relieving cap 20 may feature a UV safe flexible membrane of a soft durometer hardness and a high elongation and tear strength, which expands as the pressure of the ice 24 increases. The tube 12 may be held in a bracket or stand featuring a short stake 28 with mounting holes 30, to allow it to be affixed to fences or decks, or be anchored in the earth of a flower pot or lawn for easy viewing.

A method of making the present invention may include the following. The tube may be fabricated using standard tubes of clear polymer, or by a plastic injection molding process. The flexible material may be formed by molding or casting. The scale may be applied to the tube by pad printing, screen printing, applying a clear adhesive label, or by molding the ruler into the material of the tube during injection molding.

A method of using the present invention may include the following. The user would place the present invention outdoors, where it can receive the unimpeded flow of rain. When rain falls, it is collected in the tube. The user would inspect the gauge and notice where the top of the water column registers on the scale, and learn how much rain has fallen. If temperatures fall to below freezing, the user is not inconvenienced by the gauge breaking. When the frozen precipitation melts, the bottom membrane returns to its original form, and the collected precipitation may be measured, as usual.

It should be understood, of course, that the foregoing relates to exemplary embodiments of the invention and that modifications may be made without departing from the spirit and scope of the invention as set forth in the following claims.

What is claimed is:

1. A rain gauge comprising:
a tube comprising a clear rigid body with a top end and a bottom end, wherein the top end comprises a rim forming an opening leading into the tube;
a plurality of graduation markings along the length of the tube; and
a cap comprising a flexible material covering the bottom end of the tube.

2. The rain gauge of claim 1, wherein the cap is attached to the bottom end of the tube by a fastener.

3. The rain gauge of claim 1, further comprising a plurality of numeric markings corresponding with the graduation markings.

4. The rain gauge of claim 1, further comprising a support holder configured to support the tube in an upright position.

5. The rain gauge of claim 4, wherein the support holder comprises a stake, wherein the tube is attached to the stake.

6. The rain gauge of claim 5, wherein the tube comprises an aperture and the stake comprises an aligned aperture, wherein the tube and the stake are attached via a rivet through the aperture of the tube and the aligned aperture of the stake,

7. The rain gauge of claim 1, wherein the bottom end of the tube comprises a bottom rim forming a bottom opening leading into the tube, wherein the cap covers the bottom opening.

8. The rain gauge of claim 7, wherein the cap comprises a top surface and a bottom surface, wherein the top surface comprises a circumferential channel, wherein the bottom rim is formed to fit within the circumferential channel and attach to the cap.

9. The rain gauge of claim 8, wherein the bottom rim is attached to the cap within the channel by a fastener.

10. The rain gauge of claim 8, wherein a portion of the top surface of the cap protrudes within the tube.
